(19) United States
(12) Patent Application Publication
(10) Pub. No.: US 2021/0365909 A1
(43) Pub. Date: Nov. 25, 2021

(54) COMPUTER SYSTEM AND METHOD FOR CONTROLLING TRADE OF COPYRIGHTED DIGITAL WORK

(71) Applicant: Digital Entertainment Asset Pte. Ltd., Singapore (SG)

(72) Inventor: Shigeru SHIINA, Tokyo (JP)

(21) Appl. No.: 17/106,025

(22) Filed: Nov. 27, 2020

(30) Foreign Application Priority Data
May 25, 2020 (JP) 2020-090735

(51) Int. Cl. G06Q 20/12; G06Q 20/38; H04L 9/32

(52) U.S. Cl. CPC G06Q 20/1235; G06Q 20/381; G06Q 2220/00; H04L 2209/38; H04L 2209/603; H04L 9/321

(57) ABSTRACT

A copyrighted digital work trade support system includes: a content providing section for providing a content to users, giving an object in accordance with a use status of the content, and managing the object for each of the users; a user's crypto asset management section for managing, for each of the users, a crypto asset owned by the user; a right-of-use management section for managing, for each of the users, a right of use of a copyrighted digital work owned by the user; a transfer trade processing section for providing a transfer trade function that mediates sale and purchase of the right of use between the users using the crypto asset; and a crypto asset exchange control section for giving a crypto asset corresponding to a given price to the user from a predetermined crypto asset account, in exchange for the object owned by the user.

### CROSS REFERENCE TO RELATED APPLICATION

This application is based upon and claims the benefit of priority to Japanese Patent Application No. 2020-90735 filed on May 25, 2020, the entire contents of which are incorporated herein by reference.

### BACKGROUND

Various copyrighted digital works as digital art works, such as illustrations, computer graphics (CG) models, comics, music, and writing, are widely used by consumers via networks. Online games use CG models of characters, music distribution sites provide songs, and some websites provide comics as digital books.

Because copyrighted digital works are digital data, they have been considered to be more vulnerable to unauthorized use in terms of copyright (in particular, unauthorized use or duplication), compared with artwork as a physical entity (such as paintings, sculptures, and the like).

However, with the recent advent of blockchain, i.e., a distributed ledger technology, some patent documents have disclosed technologies for managing copyright management information of copyrighted digital works that use the blockchain characteristics of enabling data storage with a reduced risk of data falsification (see, for example, Japanese Translation of PCT International Application Publication No. JP-T-2019-512778, International Publication No. WO2015/024129, and U.S. Patent Application Publication No. 2015/0310476).

### BRIEF DESCRIPTION OF THE DRAWINGS

FIG. 1 is a diagram illustrating a configuration example of a copyrighted digital work trade support system.

FIG. 2 is a diagram for describing a content play.

FIG. 3 is a diagram for describing exchange of an object for a crypto asset.

FIG. 4 is a diagram for describing a trade of a right to use a copyrighted digital work.

FIG. 5 is a diagram for describing remittance of a crypto asset in trading a right to use a copyrighted digital work.

FIG. 6 is a diagram for describing a transfer of a right to use a copyrighted digital work.

FIG. 7 is a diagram for describing use of a copyrighted digital work by a user having a right to use the copyrighted digital work.

FIG. 8 is a diagram for describing how a special benefit is given during the use of a content, to a user who has a right to use a copyrighted digital work.

FIG. 9 is a block diagram illustrating a function configuration example of a copyrighted digital work trade support system.

FIG. 10 is a diagram illustrating an example of programs and data stored in a storage section of a content providing server system.

FIG. 11 is a diagram illustrating a data configuration example of content management data.

FIG. 12 is a diagram illustrating a data configuration example of user management data.

FIG. 13 is a diagram illustrating a data configuration example of content progress control data.

FIG. 14 is a diagram illustrating an example of programs and data stored in a storage section of a trade management server system.

FIG. 15 is a diagram illustrating an example of programs and data stored in a storage section of a crypto asset management server system.

FIG. 16 is a diagram illustrating an example of programs and data stored in a user terminal.

FIG. 17 is a flowchart for describing a flow from content play in a user terminal to provision of an object.

FIG. 18 is a flowchart for describing a process flow for exchanging an object for a crypto asset.

FIG. 19 is a flowchart for describing a process flow relating to a trade of a right to use a copyrighted digital work and use of the copyrighted digital work for which the user has the right of use.

FIG. 20 is a diagram for describing a modification example of remittances of a selling/purchase price, a reward money, and a brokerage fee.

### DESCRIPTION OF EXEMPLARY EMBODIMENTS

The following disclosure provides many different embodiments, or examples, for implementing different features of the provided subject matter. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed. Further, when a first element is described as being “connected” or “coupled” to a second element, such description includes embodiments in which the first and second elements are directly connected or coupled to each other, and also includes embodiments in which the first and second elements are indirectly connected or coupled to each other with one or more other intervening elements in between.

From the standpoint of a user who uses a copyrighted digital work under an existing type of use, as have been done in online games or music distribution, the user pays the game fee or the price and is allowed to use copyrighted digital works, as one of many unspecified users. In this type of use, the user cannot exclusively own or use the copyrighted digital works, unlike the exclusive ownership of an artwork having a physical entity.

However, some core users desire such exclusive ownership and use. Some core users desire to obtain, for example, an illustration of a character drawn on a game card used in an online card game or a different illustration drawn by the same author, and also desire to collect or exclusively use the illustration.

Establishment of a mechanism (for example, an auction site) for selling and purchasing a right of use of a copyrighted digital work may satisfy the desire of core users to exclusively use the work and may also increase the income of the author; however, this mechanism is insufficient to allow general users to widely recognize or feel familiar with the mechanism or to make use of the mechanism relatively easily. More specifically, among the users who use previously-known online games or music distribution sites, only few users would search for an auction site of copyrighted digital works, and even fewer users would have strong motivation to obtain a membership and prepare for the payment procedures to start sales and purchases of the rights of use of copyrighted digital works. In particular, when the means of payment is a crypto asset using a blockchain, the blockchain-based crypto asset is not yet popular enough to be a daily payment means, and hence the user is likely to hesitate in the procedures for opening a crypto asset account (wallet) and accompanying submission of personal information.

Moreover, from the standpoint of the existing content providers related to copyrighted digital works (such as online game operators using illustrations of characters), they have been looking for a new mechanism that enables many users to effectively enjoy a game for a long period of time, in addition to traditional promotion means, such as a web advertisement, a magazine advertisement, or a TV advertisement.

The present specification discloses an exemplary embodiment that was made in comprehensive consideration of various requirements in different standpoints related to creation and use of copyrighted digital works. The present specification discloses an exemplary embodiment that can provide an advantageous mechanism for all parties involved in creation and use of copyrighted digital works, including users who use contents employing copyrighted digital works, authors of the copyrighted digital works, and content providers.

In accordance with one of some embodiments, there is provided a computer system comprising:

at least one processor or circuit programmed to:

provide a content to users;

give an object in accordance with a use status of the content and manage the object for each of the users;

connect to a first blockchain network that relates to a first blockchain in which information regarding a trade of a crypto asset is written, and manage, for each of the users, the crypto asset owned by the user;

connect to a second blockchain network that relates to a second blockchain in which information regarding a trade of a right of use of a copyrighted digital work is written, and manage, for each of the users, the right of use owned by the user;

provide a transfer trade function that mediates sale and purchase of the right of use between the users using the crypto asset; and

give the crypto asset corresponding to a given price to the user from a predetermined account related to the first blockchain network, in exchange for the object owned by the user.

The “computer system” may be realized not only by a single computer but also by cooperation of a plurality of computers.

The “crypto asset” is a digital currency (one of crypto assets in the narrower sense) that can be used as a substitute for legal currency and that can be transferred as the price of transfer of a service or a product.

The “content” is, for example, a game, a still image such as an illustration or a photograph, a moving image, a comic, music, a novel, or the like.

The “object” can arbitrarily be given to a user by the content provider or the content operator. The object may be any object regardless of the type or category of the content, as far as the system can recognize the occurrence of giving (i.e., whether the object has been given or not), the number of occurrences of giving (i.e., how many times the object has been given), and the quantity of objects given to the user (i.e., how many objects have been given). For example, the object may be a virtual ticket. When the content is a game, the object may be a currency, an item, or the like that can be used in the game world.

The “use status” corresponds to the number of uses, accumulation of use time, and frequency of use. When the content is a game, the result of gameplay (for example, a game point, a level of a player character, a degree of progress of the game, or the like) may serve as the use status.

According to the first aspect, a user can obtain an object by using a content, and can convert the object into a crypto asset that is managed by a first blockchain network. More specifically, the user can obtain a crypto asset by a simple act of using the content. Then, using the crypto asset, the user can trade a right of use of a copyrighted digital work. The right of use of the copyrighted digital work obtained by the trade is managed by a second blockchain network. It is clear that the user who has the right to use the copyrighted digital work can sell the right to other users.

From the standpoint of the user, the user can obtain the crypto asset required for the trade by using a content, so that the user can more easily join the trade of the right to use a copyrighted digital work.

From the standpoint of the author of a copyrighted digital work, the author can sell the right to use his/her work to a user. Establishing such a new mechanism of enabling the author to obtain income helps to improve author's motivation in creative activities.

From the standpoint of the content business provider, this mechanism itself, in which a right of use of a copyrighted digital work is tradable by a simple act of playing a content, produces a new promotion effect which did not exist in the past.

Therefore, it is possible to provide a new mechanism that gives advantages to all parties involved in the creation and use of copyrighted digital works, including users who use contents employing copyrighted digital works, authors of the copyrighted digital works, and content providers.

In accordance with one of some embodiments, there may be provided the computer system, wherein

the at least one processor or circuit is further programmed to:

connect to the first blockchain network and manage the crypto asset owned by an author of the copyrighted digital work, an author who is also a copyright holder of the copyrighted digital work, or the like; and

collect the crypto asset corresponding to a predetermined reward money for sale and purchase of the right of use upon intermediation of the sale and purchase, and give the crypto asset to the author or the like.

As a result, a crypto asset is given to the author of the copyrighted digital work as the reward money corresponding to the sale/purchase of the right of use of the work. The sale and purchase of the right of use includes not only a sale from an author to a user but also a transfer of a right to use a copyrighted digital work from a right-holder user to another user. Such forms of sale/purchase increase the author's opportunity to obtain income, and can further support authors in their creative activities.

In accordance with one of some embodiments, there may be provided the computer system, wherein

a character or the like appears in the content, the character or the like comprising a plurality of characters and/or items for which parameters are set, and

the copyrighted digital work is a copyrighted work that relates to an image of the character or the like.

The “copyrighted work related to an image of a character or the like” includes an image of a character, a CG model of a character, equipment items (for example, weapons, protective tools, costumes, small items, and the like) owned by a character, a voice of a character, theme music or theme song of a character, and the like.

As a result, during the content play, the user gets attached to the character of the content and is greatly encouraged to collect and cherish the character.

In accordance with one of some embodiments, there may be provided the computer system, wherein

providing the content includes giving a special benefit related to the content to the user having the right of use.

As a result, the user having the right of use of the copyrighted digital work obtains a special benefit that gives an advantage during the content play. Therefore, the users are more strongly invited to trade the rights to use copyrighted digital works. The resulting rise in the trade of the right of use increases the income of the authors, encourages the users to play the content more actively, and thereby benefits the content providers.

In accordance with one of some embodiments, there may be provided the computer system, wherein

providing the content includes giving a special benefit related to the content to the user having the right of use, by changing a value of the parameter of the character or the like corresponding to the right of use.

As a result, it is possible to change the value of the parameter set for the character (for example, when the content is a game, the value of the parameter to set the ability or skill of the character). Since the possession of the right of use realizes a richer experience in playing the content, the users can be more strongly invited to trade the rights to use copyrighted digital works.

In accordance with one of some embodiments, there may be provided the computer system, wherein

providing the content includes giving a special benefit related to the content to the user having the right of use, after changing the special benefit according to how many rights of use related to the same character or the like are owned by the user.

As a result, the user can obtain a special benefit or reward corresponding to the number of owned rights of use. In this way, the users are more strongly invited to trade the rights to use copyrighted digital works.

In the computer system in accordance with one of some embodiments, the content may be a game.

As a result, since the use status of the content has a wider variety than the contents of other categories, it becomes easier to make a difference in the reason for giving an object and the object to be given. This increases the motivation of the user (in this case, the player) to play the content. This further enhances the cycle to produce advantages for the three parties, i.e., the user, the author, and the content provider.

Further, in the computer system in accordance with one of some embodiments, the content may be a comic.

A comic is one of popular contents. If a single comic book is regarded as a single content, a full-length series of comics have many contents.

Since the use status of the content has a wide variety comparable to that of the game content, it becomes easier to make a difference in the reason for giving an object and the object to be given. For example, it is possible to give an object every time the user finishes 1 story (1 content) out of the whole 10 stories (10 contents) of the comic, or to give an object when the user finishes all of the 10 stories. This increases the motivation of the user (in this case, the player) to play the content. This establishes the cycle to produce advantages for the three parties, i.e., the user, the author, and the content provider.

Further, in the computer system in accordance with one of some embodiments, giving the crypto asset to the user in exchange for the object may include determining the price with respect to the object based on a given exchange rate; and providing the content may include setting the exchange rate.

The start of the cycle of “giving an object to a user→inviting the user to trade the right of use of a copyrighted digital work, and thereby activating the trade→encouraging the user to use the content more actively through the ownership of the right of use” is the act of giving an object to a user who has used the content.

As a result, since the computer system is capable of setting the rate of exchange of an object for a crypto asset, the intensity of inviting the user to trade the right of use of a copyrighted digital work, and eventually the intensity of the cycle, can be adjusted by adjustment of the exchange rate.

In particular, if the computer system is configured to provide the exchange rate for each content and to allow involvement of the content provider in the process of setting the exchange rate, the exchange rate can be adjusted in accordance with the operation situation of the content provider. This improves the usability of the system as the promotion means.

A second aspect of the present embodiment is a method for controlling a trade of a copyrighted digital work executed by a computer system, the method comprising:

providing a content to users;

giving an object in accordance with a use status of the content and managing the object for each of the users;

connecting to a first blockchain network that relates to a first blockchain in which information regarding a trade of a crypto asset is written, and managing, for each of the users, the crypto asset owned by the user;

connecting to a second blockchain network that relates to a second blockchain in which information regarding a trade of a right of use of a copyrighted digital work is written, and managing, for each of the users, the right of use owned by the user;

providing a transfer trade function that mediates sale and purchase of the right of use between the users using the crypto asset; and

giving the crypto asset corresponding to a given price to the user from a predetermined account related to the first blockchain network, in exchange for the object owned by the user.

According to the second aspect, the method enables control of the trade of a copyrighted digital work, which exhibits the same advantageous effect as that of the first embodiment.

Exemplary embodiments are described below. Note that the following exemplary embodiments do not in any way limit the scope of the content defined by the claims laid out herein. Note also that all of the elements described in the present embodiment should not necessarily be taken as essential elements.

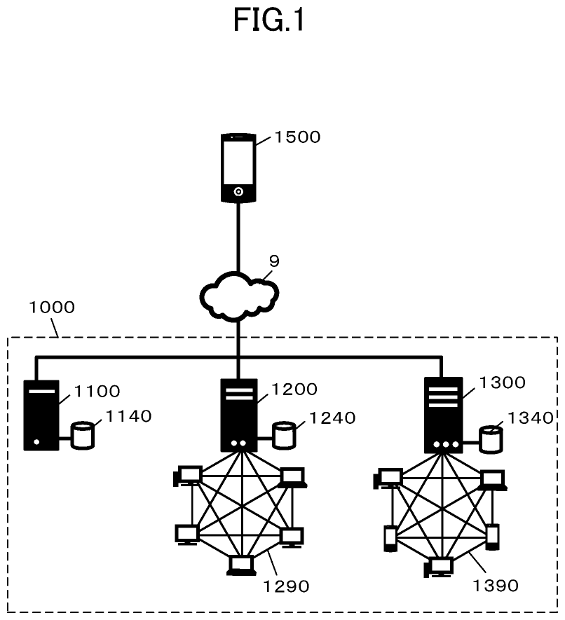

FIG. 1 is a diagram illustrating a configuration example of a copyrighted digital work trade support system.

A copyrighted digital work trade support system 1000 is a computer system connected to a user terminal 1500 via a network 9, while enabling data communication with the user terminal 1500. The copyrighted digital work trade support system 1000 includes a content providing server system 1100, a trade management server system 1200, and a crypto asset management server system 1300. Although FIG. 1 illustrates only one user terminal 1500 to simplify the explanation, there are in fact many user terminals 1500 of many users.

The network 9 is a communication channel that enables data communications. Specifically, the network 9 includes a communication network such as a local area network (LAN) using a private line (a private cable) for direct connection, Ethernet (registered trademark), or the like, a telecommunication network, a cable network, the Internet, and the like. A communication method may be a cable communication method or a wireless communication method.

The content providing server system 1100 is a computer system that provides content play environment to a user 2 who uses the user terminal 1500.

There are multiple types of contents available, and the user 2 can select any contents from them. Examples of the contents include, but not limited to, playing an online game, reading a comic, viewing an illustration, listening to a music, and viewing a moving image. Each content is provided by a content provider. The material of the content, the method for providing the content, the price of the content, and the like are set for each content.

For the purpose of description, an online game is taken as an example of the content in this embodiment, in which case the content providing server system 1100 is a game server.

The content providing server system 1100 is independent from a trade management blockchain network 1290 and a crypto asset management blockchain network 1390. Therefore, even if the trade management blockchain network 1290 or the crypto asset management blockchain network 1390 temporarily stops the operation due to a trouble, maintenance, or for some other reason, the content providing server system 1100 can operate without a problem during that time.

The trade management server system 1200 provides a trading site for the right of use of a different copyrighted digital work created by the author of the copyrighted digital work used in the content (for example, an illustration of a character of a game, a CG model of the character or his/her equipment item or the like, a voice of the character, and the like). In the present embodiment, the trade is made in the form of an online auction. However, a different form may be used for the trade.

The trade management server system 1200 sets a limited number of exclusive rights of use (corresponding to the ownership of the copyrighted digital work) to an original copyrighted digital work created by the author, and manages information of each right of use (unique information indicating the owner of the right of use) in a blockchain as a non-fungible token (NFT).

More specifically, the trade management server system 1200 is connected to the trade management blockchain network 1290 to generate a transaction for including right-of-use setting information that reflects the closed trade result in a new block. When the transaction is approved by the trade management blockchain network 1290, a new block is added. Blockchain data, which is a ledger including information regarding the setting of the right of use, is dispersively managed by nodes of the trade management blockchain network 1290. The trade management server system 1200 may serve as one of the nodes of the trade management blockchain network 1290. The trade management blockchain network 1290 is independent from the crypto asset management blockchain network 1390. Therefore, even if the crypto asset management server system 1300 temporarily stops the operation due to a system trouble, a malfunction, maintenance, or for some other reason, the trade management server system 1200 can operate without a problem during that time.

Further, the trade management server system 1200 provides a user who has registered as a participant with a service regarding exclusive use of a copyrighted digital work for which the user has a right of use. For example, when the copyrighted digital work is a still image (such as an illustration) or a moving image, the trade management server system 1200 provides a so-called “my gallery” function, which gives a list of owned items in the user terminal 1500 and enables the user to select and browse a desired item.

The crypto asset management server system 1300 manages a crypto asset account owned by a user who has made an account management contract.

More specifically, the crypto asset management server system 1300 is connected to the crypto asset management blockchain network 1390 to generate a transaction for including information of remittance between accounts in a new block, and send it to the crypto asset management blockchain network 1390. Blockchain data, which is a ledger of crypto assets, is dispersively managed by nodes of the crypto asset management blockchain network 1390. The crypto asset management server system 1300 may serve as one of the nodes of the crypto asset management blockchain network 1390.

FIG. 1 illustrates each of the trade management server system 1200 and the crypto asset management server system 1300 as a single server device; however, they may be implemented by a plurality of devices. For example, these server systems may include a plurality of blade servers that are connected together via an internal bus in a data communicable manner to share the respective functions. Further, the hardware constituting these server systems can be installed at any place without limitation. A plurality of independent server devices installed at distant places may be allowed to communicate data via the network 9 to thereby function as a single server system as a whole. It is also clear that the trade management server system 1200 and the crypto asset management server system 1300 may be configured as the same server system.

The user terminal 1500 is a computer system capable of executing an application program. The user terminal 1500 have a form of, for example, a smartphone, a laptop computer, a tablet computer, or a wearable computer such as a wristwatch-type computer. In the case where a plurality of electronic devices is communicably connected (for example, a combination of a smartphone and a smartwatch communicably connected to the smartphone) to perform a single function, the plurality of electronic devices can be regarded as a single user terminal 1500.

The user terminal 1500 functions as a play terminal device for enjoying a content by logging into the content providing server system 1100. Further, by logging into the trade management server system 1200, the user terminal 1500 functions as a trade terminal device that participates in the trade of a right to use a copyrighted digital work. Furthermore, by logging into the crypto asset management server system 1300, the user terminal 1500 functions as an account activity order terminal device that controls account activity of the account of the user.

Although FIG. 1 illustrates only one user terminal 1500 many other user terminals 1500 of more users can access the copyrighted digital work trade support system 1000 in an actual system operation.

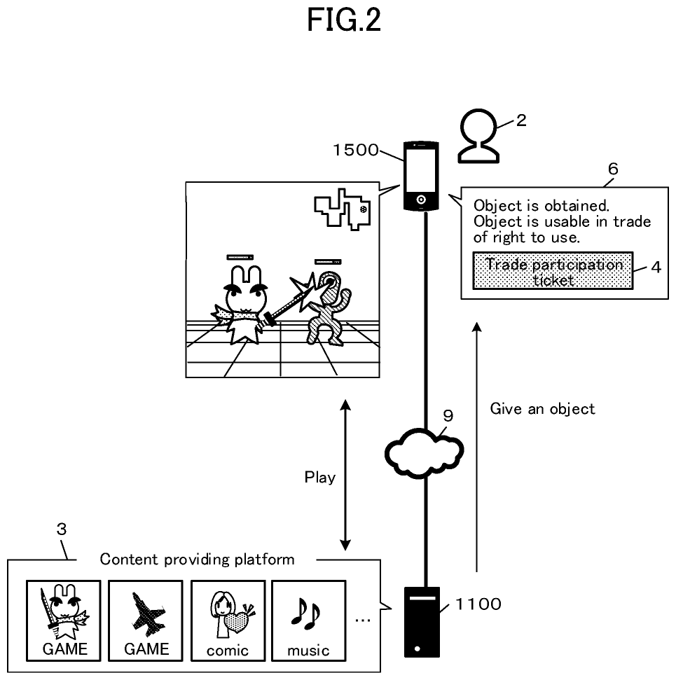

FIG. 2 is a diagram for describing a content play (use of a content in the user terminal 1500). The user 2 can register himself/herself as a user by gaining access to the content providing server system 1100 using the user terminal 1500. When the user registration is completed, the user 2 can select a desired content from various contents provided by a content providing platform 3 provided by the content providing server system 1100, and play (use) the selected content in the user terminal 1500.

Then, the user 2 can receive an object 4 from the content providing server system 1100 in accordance with the use status of the content.

The content providing server system 1100 manages the number of times of use, the duration of use, and the frequency of use for each content for each user, and determines the “use status” based on these. More specifically, the content providing server system 1100 determines how much (how many times, how long, how often, etc.) the user 2 has used the content. When the content is a game, the use status may be determined according to the result of gameplay (for example, a game point, a level of a player character, a degree of progress of the game, or the like).

The “object” can arbitrarily be given to a user 2 by the content provider. The object may be any object regardless of the type or category of the content, as far as the content providing server system 1100 can recognize the occurrence of giving (i.e., whether the object has been given or not), the number of occurrences of giving (i.e., how many times the object has been given), and the quantity given to the user (i.e., how many objects have been given). For example, the object may be a ticket (virtual ticket) to participate in the trade of a right of use of a copyrighted work. When the content is a game, the object may be a currency, an item, or the like that can be used in the game world.

For a user 2 whose use status of the content is higher (for example, a user 2 who uses the content for a greater number of times, for a longer duration, or more often, or who has a higher-level player character), the content providing server system 1100 gives more objects 4.

When the object 4 is given, an object giving notification 6 is displayed in the user terminal 1500. The notification in the object giving notification 6 includes a message that the object is usable in a trade of a right to use a copyrighted digital work.

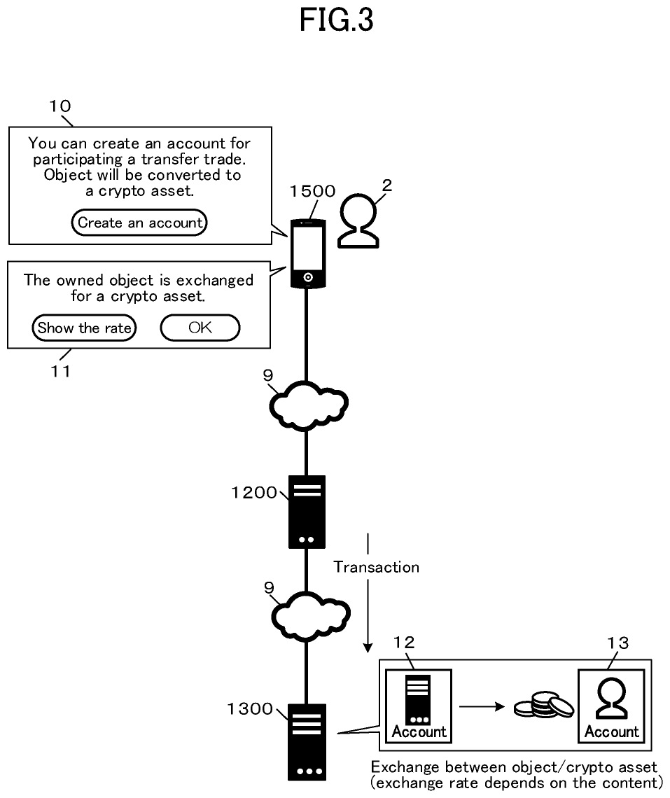

FIG. 3 is a diagram for describing exchange of the object 4 for a crypto asset.

The place for trading a right of use of a copyrighted digital work is provided in the form of an auction site or the like. The user 2 can use the service by activating a web browser program and accessing the auction site by means of the user terminal 1500. Alternatively, in an application program for using the content, the user 2 may perform a predetermined operational input for participation in the trade, in response to which the user terminal 1500 accesses the trade management server system 1200 and enables user's participation in the trade.

The trade of the right of use of a copyrighted digital work employs crypto assets for the payment of the transfer of right.

Therefore, the trade participant needs to open a crypto asset account (corresponding to those called a crypto asset address, a deposit address, a wallet, or the like of a known crypto asset) in advance. Further, in order to perform a trade using a crypto asset, the crypto asset needs to be deposited in the account in advance. For example, a would-be trade participant purchases a crypto asset in cash at a crypto asset exchange and deposits the crypto asset into his/her account. In contrast, the user 2 who uses the content can obtain a crypto asset corresponding to the object 4 owned by the user 2, and does not have to purchase a crypto asset at the crypto asset exchange.

More specifically, if the user 2 does not have a crypto asset account, the trade management server system 1200 additionally causes the user terminal 1500 to display an account opening guide notification 10 and performs control to guide the user 2 to a procedure for opening an account. The newly opened account serves as a purchaser account 13 in which the user 2 deposits crypto assets for purchasing a right to use a copyrighted digital work.

When the user terminal 1500 accesses the trade management server system 1200, the trade management server system 1200 causes the user terminal 1500 to display an exchange approval request display 11. The exchange approval request display 11 notifies that the object 4 owned by the user 2 can be exchanged for a crypto asset at a predetermined exchange rate, and requests an approval operation input to exchange the object 4 for a crypto asset. When an exchange approval operation input is performed in the user terminal 1500, the object 4 is consumed, and in return, a crypto asset of a given price calculated according to the exchange rate is transferred to the account (the purchaser account 13) of the user 2.

For the consumption of the object 4, the trade management server system 1200 sends a consumption request to the content providing server system 1100 using the user ID of the user 2 that is used during the content play. The content providing server system 1100 responds to this request.

The “exchange rate” is set for each content. Information indicating the exchange rate is stored and managed for each content by the content providing server system 1100. Each exchange rate is changeable and provided by a content provider of the content. More specifically, the content providing server system 1100 provides a content provider with an exchange rate setting function for setting the exchange rate. It is also clear that the information indicating the exchange rate may be stored and managed in the trade management server system 1200.

The crypto asset corresponding to the price is transferred from a predetermined exchange account 12, for which the trade management server system 1200 can order money transfer, to the purchaser account 13 of the user 2. The “exchange account” herein can be set as appropriate, and may be, for example, an account prepared by a system administrator of the crypto asset management server system 1300, an account prepared by (an operator of) the trade management server system 1200, an account prepared by a content provider of the content, an account prepared by a promoter, or the like.

Even if the user 2 becomes interested in the trade of the right of use of a copyrighted digital work in response to the object giving notification 6 (see FIG. 2), the degree of the interest varies among individuals. A strongly interested user 2 is willing to purchase a crypto asset in advance to participate in the trade. On the other hand, many users 2 are likely to worry that the pre-purchased crypto asset and the time and labor spent for the advance purchase may end up in waste, and thus are likely to hesitate to participate in the trade. However, in the present embodiment, even a hesitant user 2 can obtain a crypto asset in exchange for the object 4 that is obtained for free by playing the content. The present embodiment can thus invite the worried and hesitant users 2 to participate in the trade.

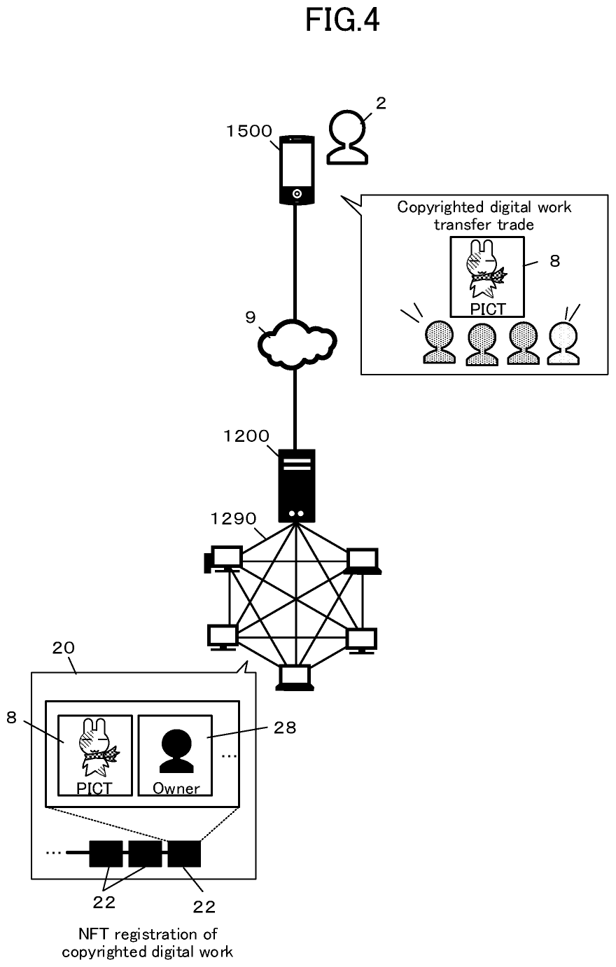

FIG. 4 is a diagram for describing a trade of a right to use a copyrighted digital work.

The place for trading the right of use of a copyrighted digital work is provided in the form of an auction by the trade management server system 1200. In other words, the trade management server system 1200 provides a transfer trade function that mediates the sales and purchases of the right of use of a copyrighted digital work using crypto assets between users.

The copyrighted digital works to be traded (hereinafter referred to as “trade target(s) 8”) include a copyrighted digital work created by the author of the copyrighted digital work used in the content provided by the content providing server system 1100.

For example, in the case where the game content uses an illustration of a game character created by a designer, the trade targets 8 include not only the copyrighted digital works relevant to the illustration but also other copyrighted digital works drawn by the same designer (including, for example, copyrighted works related to the character used in the game content, such as an illustration of the character in a different costume or in a different situation, an illustration of a tool or equipment used by the character, an illustration of a family member of the character or someone else related to the character).

The trade targets 8 may also include secondary copyrighted works relating to the character (for example, a voice, a CG model, a moving image or a comic featuring the character, a song sung by a voice actor of the character, or the like).

The trade targets 8 may also include an illustration of another character created by the same author of the copyrighted digital work used in the content and intended to appear in the same game content, and may also include secondary copyrighted works that relate to such a character.

The owner user ID 28 for the user of the right of use of the trade target 8 (copyrighted digital work to be traded) is managed by a trade management blockchain 20 of the trade management blockchain network 1290 to thereby ensure monopolization of the right of use of a copyrighted digital work. More specifically, an original copyrighted digital work as the trade target 8 is copied in a limited number, and each copy of the copyrighted digital work is managed by a block 22 of the trade management blockchain 20, together with each corresponding owner user ID 28 (unique information indicating the owner of the right of use) that serves as an NFT (Non-fungible token).

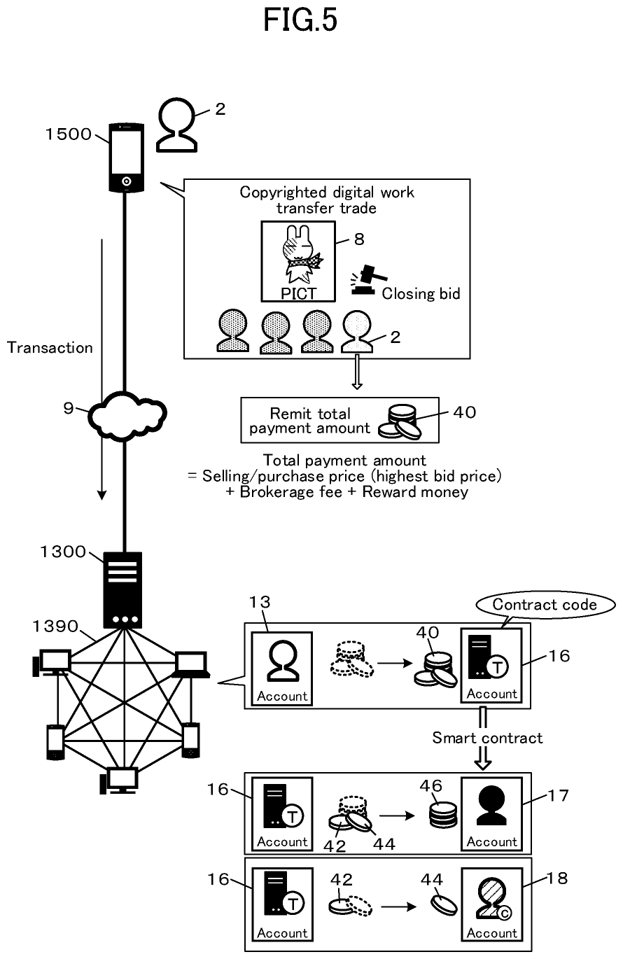

FIG. 5 is a diagram for describing remittance of a crypto asset in trading a right to use a copyrighted digital work. When the trade of a right to use a copyrighted digital work is made, the trade management server system 1200 notifies the user 2, via the user terminal 1500, of the following: the total payment amount 40 that is the sum of the selling/purchase price, a given brokerage fee and a given reward money; information of the payment account of the crypto asset corresponding to the total payment amount; an order of sending the total payment amount 40 to the payment account; and a message that the right of use will be transferred after the remittance is confirmed.

In response to this notification, the purchasing user 2 transfers the crypto asset corresponding to the total payment amount 40 from his/her own crypto asset account (purchaser account 13) to the payment account (more specifically, a trade manager account 16 prepared in advance by the trade management server system 1200). That is, the trade management server system 1200 has a function of collecting, from the purchasing user 2, a crypto asset that relates to a trade required for the transfer of the right of use.

A mechanism for enabling a smart contract is associated with the trade manager account 16 in advance. The details of the smart contract are described and defined using a code provided by the crypto asset management server system 1300. A smart contract that is set for the trade manager account 16 executes (1) a process of checking whether the remittance matches the total payment amount 40, (2) when the total payment amount 40 is paid, a process of remitting a crypto asset as a selling/purchase price 46 to the seller account 17 (an account previously designated by the seller upon the participation in the trade), the selling amount 46 being obtained by subtracting a given brokerage fee 42 and a reward money 44 from the total payment amount 40 to the seller account 17 (an account previously designated by the seller upon the participation in the trade), and (3) a process of remitting a given reward money from the trade manager account 16 to the author account 18.

The author account 18 is an account for managing crypto assets owned by the author of the sold/purchased copyrighted digital work. The author account 18 is confirmed and set previously by the trade management server system 1200 when the copyrighted digital work is set as a trade target.

Therefore, when the purchasing user 2 transfers the crypto asset corresponding to the total payment amount 40 to the trade manager account 16, the author of the trade target 8 obtains income corresponding to the trade. The balance of the remittance from the trade manager account 16 to the author account 18 is the brokerage fee 42 for the operator of the trade management server system 1200.

That is, the crypto asset management server system 1300 performs (1) a participant crypto asset management function that manages a crypto asset of a participant who participates in the trade of a right to use a copyrighted digital work, (2) a trade manager crypto asset management function that manages a crypto asset of the operator of the trade management server system 1200, and (3) an author's currency management function that manages a crypto asset of the author of the copyrighted digital work. In addition, the crypto asset management server system 1300 also has a reward money giving control function that collects a crypto asset corresponding to a predetermined reward money for the sale/purchase of the right of use upon the intermediation of the sale/purchase, and gives the collected crypto asset to the author.

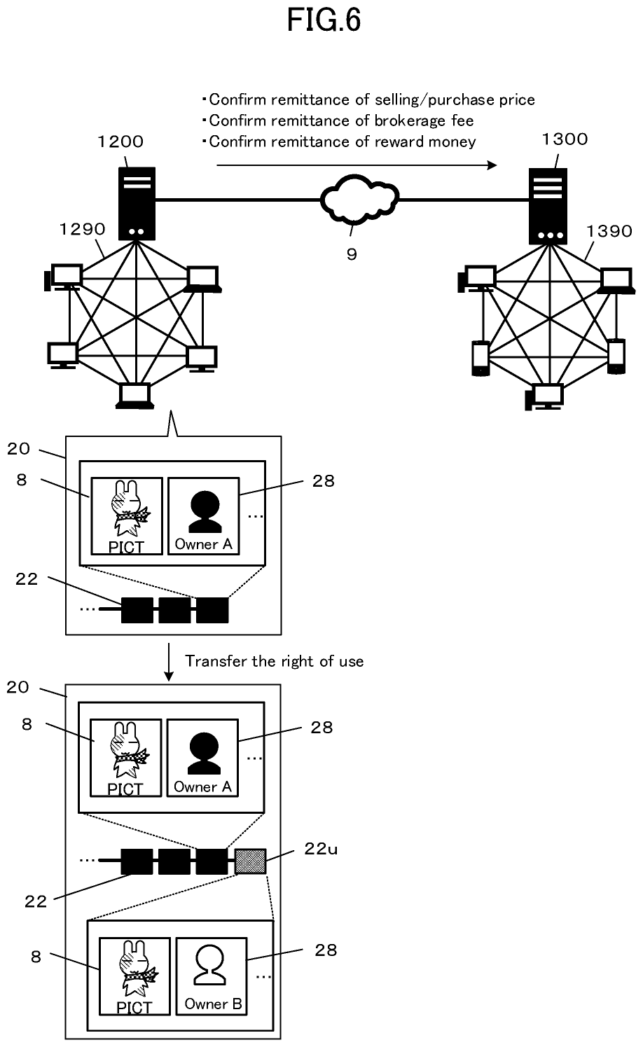

FIG. 6 is a diagram for describing a transfer of a right to use a copyrighted digital work.

The trade management server system 1200 confirms remittance of a crypto asset corresponding to the selling/purchase price, remittance of a crypto asset corresponding to the brokerage fee, and remittance of a crypto asset corresponding to the reward money to the author. Specifically, the trade management server system 1200 checks the balance of the trade manager account 16 (see FIG. 5).

After the confirmation, the trade management server system 1200 generates a transaction to transfer the right of use of the traded copyrighted digital work, and updates the trade management blockchain 20. Thus added to the blockchain is a new block 22u in which the purchasing user 2 is associated as a new owner with the right of use of the traded copyrighted digital work.

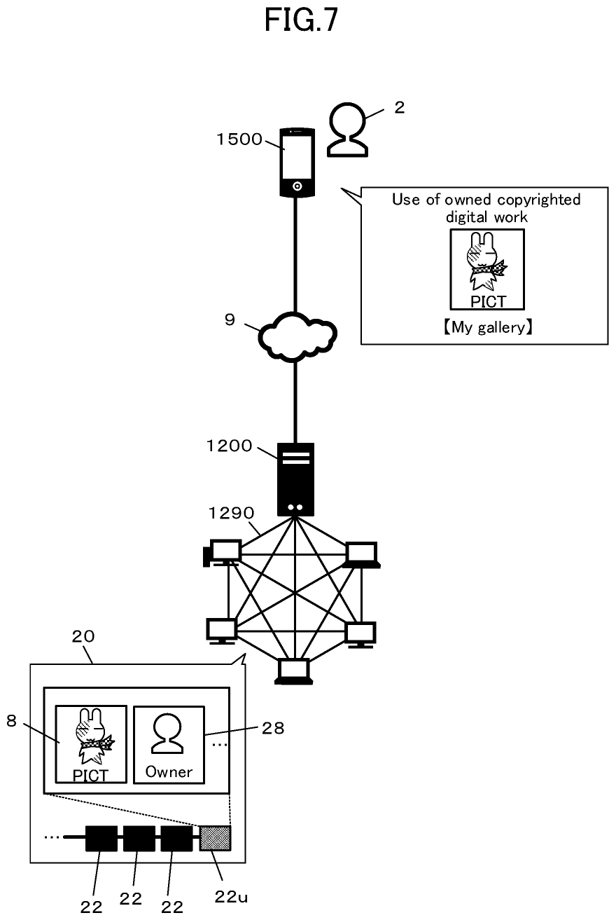

FIG. 7 is a diagram for describing use of a copyrighted digital work by the user 2 having a right to use the copyrighted digital work.

For the user 2 having the right of use, the trade management server system 1200 provides control of exclusive use of the copyrighted work, and control of providing a use environment. Specifically, when the user terminal 1500 executes an application program to participate in a trade of the right of use, the user terminal 1500 implements a function of participating in the trade and a function of requesting use of the owned copyrighted work. When the user terminal 1500 detects a predetermined use request operation input (for example, an operation input for selecting a desired item from a menu), the user terminal 1500 sends a use request to the trade management server system 1200 together with the user ID. The trade management server system 1200 confirms the ownership of the right of use by referring to the trade management blockchain 20 based on the received user ID, and permits the use of the copyrighted work if the request was made by the owner. Then, the user terminal 1500 is caused to provide use environment of the owned copyrighted digital work. For example, the trade management server system 1200 provides a so-called “my gallery” function, which enables the user to browse the owned copyrighted digital works.

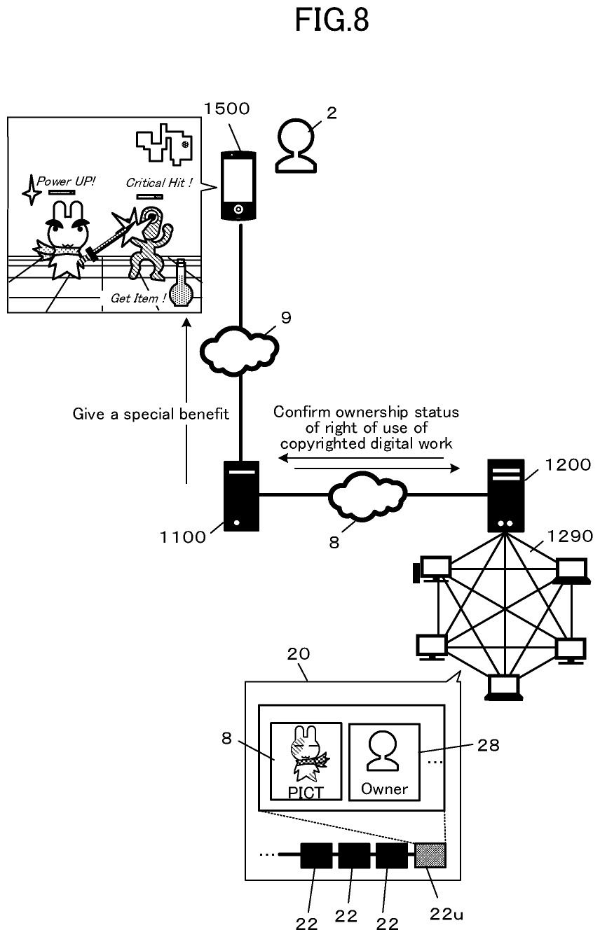

FIG. 8 is a diagram for describing how a special benefit is given during the use of a content, to the user 2 who has a right to use a copyrighted digital work. When the user 2 having the right of use of a copyrighted digital work uses a content, the content providing server system 1100 gives a content-related special benefit to the user 2 having the right of use.

For example, in the case of a game content, a special benefit to the user 2 having the right of use is to change the parameter value of the character corresponding to the right of use. More Specifically, when the user 2 has a right of use of an illustration (copyrighted digital work) of a character in the game, another character related to the character, equipment of the character, or the like, the content providing server system 1100 changes a parameter value in the game progress control, such as a parameter value related to the character (for example, endurance such as HP (hit point), offensive power, defensive power, traveling force, skill, probability of hit determination upon attack, probability of protection determination, and the like), a parameter value of a weapon or the like owned by the character, etc. Further, the parameter value can be changed to give an advantage to the player (user 2) while playing the content.

Further, for example, in the case of a comic content, a special benefit to the user 2 having the right of use is to change the parameter value that relates to the control for providing the content. More specifically, such a parameter may be appropriately set with respect to the change in the upper limit of the image resolution upon the provision, activation/inactivation of reading of character's line by a voice actor or output of sound effects, activation/inactivation of switching between color display and monochrome display, activation/inactivation of an automatic page feed function, or the like.

Further, for a user who has the right to use a copyrighted digital work, the user may be permitted, as a special benefit, to use the copyrighted digital work in the content. For example, if the copyrighted digital work is an illustration of a character in the game, the illustration may be displayed as an artwork in the screen showing the status of the character or the screen for changing the equipment of the character. Further, it is also possible to display the illustration in a display effect such as an insert cut when the character takes an action in the game. Furthermore, the ownership of the right of use of the copyrighted digital work may allow the user to use a new character or equipment, to use a new skin of the character, or to produce a new voice of the character.

It should be noted that it is possible to set, for each content in advance, what kind of special benefit is given in which situation, depending on for which copyrighted digital work the user owns the right of use, and that the content provider can arbitrarily set and change such conditions. For example, as a possible setting, a more advantageous special benefit may be given if the user has more rights of use of copyrighted digital works related to a character in the content or if the user has the right for a longer period of time.

Such various special benefit settings in relation to the ownership of the right of use of a copyrighted digital work are effective to encourage the user 2 to collect and own more copyrighted digital works.

The next description concerns a functional configuration of the copyrighted digital work trade support system 1000 as a whole and examples of programs and data for implementing the functions.

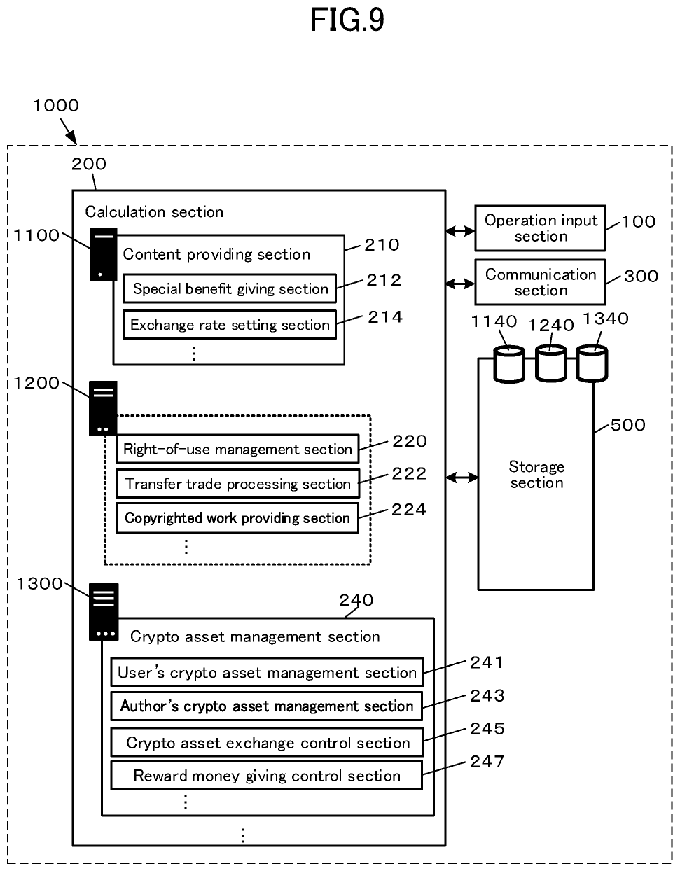

FIG. 9 is a block diagram illustrating a function configuration example of the copyrighted digital work trade support system 1000. The copyrighted digital work trade support system 1000 includes an operation input section 100, a calculation section 200, a communication section 300, and a storage section 500.

The operation input section 100 is an operation input means for a system administrator. Examples of the operation input section 100 include a keyboard, a touch panel, a mouse, and the like provided in each server system.

The calculation section 200 performs various functions of the copyrighted digital work trade support system 1000 by performing a calculation process according to a given program. Specifically, the calculation section 200 implements various functions by executing respective server programs in a central processing unit (CPU) of a control board provided in each server system.

The calculation section 200 includes a content providing section 210, a right-of-use management section 220, a transfer trade processing section 222, a copyrighted work providing section 224, and a crypto asset management section 240. The content providing section 210 is implemented by the content providing server system 1100. The right-of-use management section 220, the transfer trade processing section 222, and the copyrighted work providing section 224 are implemented by the trade management server system 1200. The crypto asset management section 240 is implemented by the crypto asset management server system 1300.

The content providing section 210 provides the user 2 with a content, gives an object 4 in accordance with the use status of the content, and manages the object for each user 2. Specifically, the content providing section 210 controls provision of a client-server type platform environment (content providing platform 3; see FIG. 2) in which the user 2 can access the platform using the user terminal 1500 to select and play a desired content from among multiple types of content. The content providing section 210 includes a special benefit giving section 212 and an exchange rate setting section 214.

The special benefit giving section 212 performs control in providing a user having a right of use of a copyrighted digital work with a special benefit related to the content used by the user (see FIG. 8).

More specifically, the special benefit giving section 212 gives a content-related special benefit to a user having the right of use, by changing the parameter value of a character corresponding to the right of use. In addition, the special benefit giving section 212 changes the content-related special benefit according to the number of rights of use of copyrighted digital works related to the same character, and gives the special benefit to the user having the right of use.

The exchange rate setting section 214 sets and manages a given exchange rate for determining a price when the crypto asset management section 240 performs control of giving a crypto asset corresponding to a given price to the user 2 from a predetermined account concerning a first blockchain network (crypto asset management blockchain network 1390), in exchange for the object 4 owned by the user 2.

The right-of-use management section 220 is connected to a second blockchain network (trade management blockchain network 1290) related to the second blockchain having information regarding the trade of a right to use a copyrighted digital work, and manages user's right of use for each user.

The transfer trade processing section 222 provides a transfer trade function that mediates the sales and purchases of rights of use between users using crypto assets.

The copyrighted work providing section 224 provides a user having a right of use of a copyrighted digital work with an environment for utilizing the copyrighted digital work, and specifically provides the “my gallery” function (see FIG. 7).

The crypto asset management section 240 is connected to the first blockchain network (crypto asset management blockchain network 1390) to manage information of the crypto asset accounts and a ledger recording the trades between the accounts. More specifically, the crypto asset management section 240 includes a user's crypto asset management section 241, an author's crypto asset management section 243, a crypto asset exchange control section 245, and a reward money giving control section 247.

The user's crypto asset management section 241 is connected to the first blockchain network (crypto asset management blockchain network 1390) related to the first blockchain having information regarding the trade of crypto assets, and manages user's crypto asset for each user.

The author's crypto asset management section 243 is connected to the first blockchain network to manage a crypto asset owned by the author (or the copyright holder) of the copyrighted digital work.

The crypto asset exchange control section 245 performs control of giving a crypto asset corresponding to a given price to the user from a predetermined account concerning the first blockchain network, in exchange for the object 4 owned by the user 2.

The reward money giving control section 247 collects a crypto asset corresponding to a predetermined reward money for the sale/purchase of the right of use upon the intermediation of the sale/purchase, and gives the crypto asset to the author. More specifically, from the crypto asset corresponding to the total payment amount 40 transferred by the purchasing user 2, the reward money 44 is transferred to the author account 18 (see FIG. 5)

The communication section 300 is connected to the network 9 to enable data communication with other computer systems and electronics. For example, the communication section 300 is implemented by a communication module or the like included in each server system.

The storage section 500 stores programs and data. The storage section 500 is implemented by, for example, an IC memory mounted on the control board of each server system, a database (see FIG. 1; database 1140, database 1240, database 1340) to which each server system can be connected, or the like.

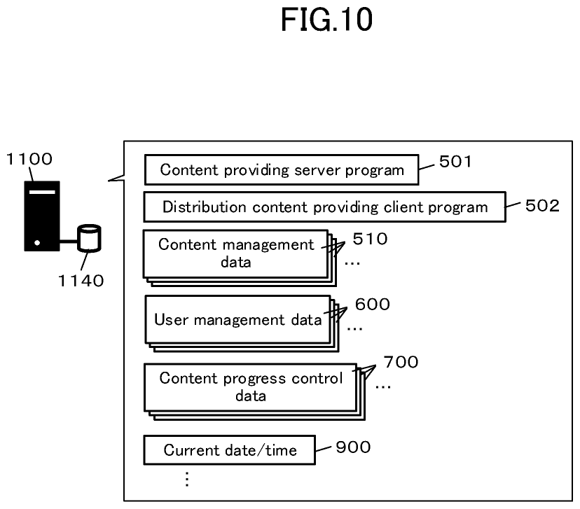

FIG. 10 is a diagram illustrating an example of programs and data stored in the storage section 500 of the content providing server system 1100. The storage section 500 of the content providing server system 1100 stores a content providing server program 501, a distribution content providing client program 502, content management data 510, user management data 600, content progress control data 700, and a current date/time 900. It is clear that the storage section 500 may store other programs and data as well.

The content providing server program 501 is a program for enabling the content providing server system 1100 to perform a calculation process in the CPU to thereby enable the function of the content providing section 210.

The distribution content providing client program 502 is a program for causing the user terminal 1500 to function as a client device to thereby enable use of a content in the user terminal 1500.

The content management data 510 is prepared for each content provided by the content providing server system 1100, and stores various programs and data related to the content.

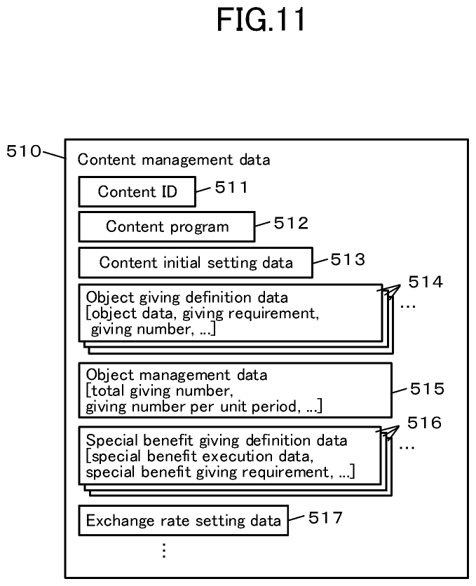

For example, as shown in FIG. 11, each piece of content management data 510 includes a unique content ID 511, a content program 512, content initial setting data 513, object giving definition data 514, object management data 515, special benefit giving definition data 516, and exchange rate setting data 517. It is clear that other kinds of data may also be included as appropriate.

The content program 512 is a main program for enabling a function of controlling execution of the content. For example, in the case of a game content, the content program 512 enables the content providing server system 1100 to perform a function as a game server, that is, a game progress control function.

The content initial setting data 513 is data regarding the material of the content. For example, in the case of a game content, the content initial setting data 513 stores game space definition data, player character or NPC character models, initial settings of parameter values for determining their abilities, and the like. In addition, the content initial setting data 513 also stores event definition data for an event such as item giving (for example, in the case of a drawing (lottery) event for determining the type of item to be given, various parameter values for initial setting of a drawing (lottery) for event occurrence or winning probability for each type, and the like), a set of an effect performing condition (such as insert cut) and effect data, and the like. If the object 4 is an item or the like used in the game, data for displaying the object in the game can also be included in the content initial setting data 513.

The object giving definition data 514 stores data for visually expressing the object 4, and is prepared for each requirement (requirement for giving) which must be satisfied to give the object 4 to the user 2. The data stored therein is associated with the number of objects 4 to be given when the requirement is satisfied.

The requirement for giving can be set as appropriate, as long as it relates to the use status of the content. For example, the requirement can be described by following conditions, as combined by AND or OR: a condition about the cumulative number of times of use of the content, a condition about the duration of use of the content, a condition about the frequency of use of the content, a condition about charging status if the game has a charging (pay-to-play) option, a condition about the play result (for example, in the case of a game content, a player level when the player level is set according to the play result, acquisition of a special item, completion of a specific event, and the like), and/or a condition about the use of a series of contents (for example, in the case of a comic content, how many stories out of 30 stories have been read in numbered order, how many of different story series have been read, etc.). It should be noted that any of these conditions describing the giving requirements can be set to “none” or “substantially unlimited”. Further, these conditions may also include a condition about the total number of objects 4 to be given.

The object management data 515 stores various types of data for managing the giving status of the object 4. For example, the object management data 515 stores the total giving number, the number of objects 4 given per unit period of time, and the like. If the object 4 is configured to be consumed upon the exchange for a crypto asset, the object management data 515 may also store the number of objects already exchanged.

The special benefit giving definition data 516 is prepared for each type of the special benefit, and stores special benefit execution data for giving the special benefit (for example, in the case of a game content, data for executing an event which gives a special benefit as a prize, definitions of the type of ability parameter of a player character and a shift amount of the parameter value thereof, definitions of the type of item to be given as a special benefit and the number of items to be given, and the like; in the case of an image content such as an illustration, a parameter value for setting the highest resolution applied upon the reproduction, and the like) in association with a special benefit giving requirement that must be satisfied to give the special benefit.

The “special benefit giving requirement” is described using information regarding the copyrighted digital works acquired and owned by the user through the trades of the rights of use of the copyrighted digital works. For example, the requirement can be described by following conditions, as combined by AND or OR: a condition about copyrighted digital work ID unique to each copyrighted digital work, a condition about the total number of copyrighted digital works for which the user has the right of use, a condition about a statistical value (for example, an average value, a maximum value, a minimum value, or the like) of the duration of the ownership of the right to use the copyrighted digital work, and/or a condition about ownership of a series of copyrighted digital works (for example, how many of a series of 10 copyrighted digital works have been obtained, the length of time spent to obtain the rights of use for all works in the series, or the like). It should be noted that any of these conditions describing the special benefit giving requirements can be set to “none” or “substantially unlimited”.

The exchange rate setting data 517 is data for setting an exchange rate when the object 4 is exchanged for a crypto asset, and is basic data for calculating the amount of the crypto asset corresponding to the price of the object 4 owned by the user 2. The exchange rate setting data 517 can be arbitrarily set and changed by a content provider who provides (or operates) the content.

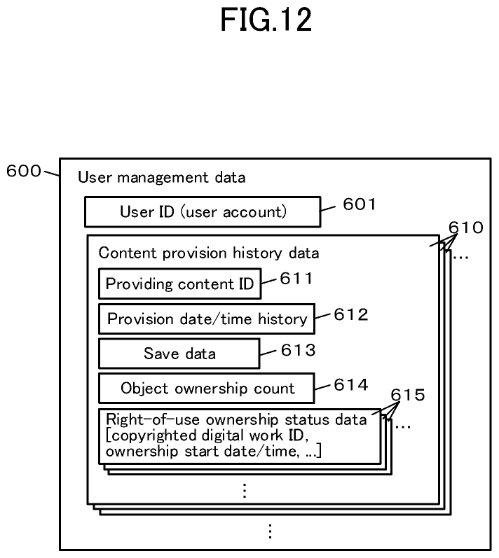

Referring back to FIG. 10, the user management data 600 is created for each time of user registration, and stores various kinds of data related to the user. For example, as shown in FIG. 12, each piece of user management data 600 includes a unique user ID 601 that is transversely used in the copyrighted digital work trade support system 1000, and content provision history data 610. It is clear that other kinds of data may also be included as appropriate.

The content provision history data 610 is prepared for each type of content supplied to the user, and stores various kinds of data related to the provision. More specifically, the content provision history data 610 includes (1) a providing content ID 611 indicating the content supplied to the user (content to be used by the user), (2) provision date/time history 612 in which the provision date and time are added each time the content is supplied, (3) save data 613 for restarting the content provision from the previous progress state, (4) an object ownership count 614, and (5) right-of-use ownership status data 615. It is clear that other kinds of data may also be included as appropriate.

The object ownership count 614 indicates the number of objects that are given to and owned by the user in relation to the content. If the object 4 is configured to be consumed upon the exchange for a crypto asset, the count is decreased by the amount of consumption at each exchange.

The right-of-use ownership status data 615 is prepared for each copyrighted digital work for which the user has the right of use, and stores various kinds of data describing the ownership status of the right of use. The right-of-use ownership status data 615 includes, for example, the copyrighted digital work ID, the start date and time of the ownership, the duration of the ownership, and the like.

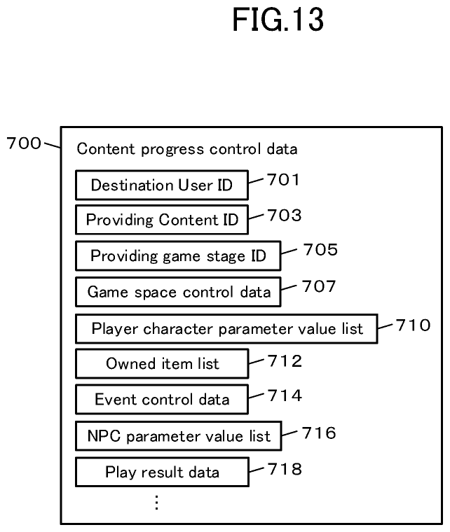

Referring back to FIG. 10, the content progress control data 700 is created each time a content is provided, and stores various types of data describing the progress status in providing the content. For example, as shown in FIG. 13, when a Role-Playing Game (RPG) is provided as a content, each piece of content progress control data 700 includes a destination user ID 701, a providing content ID 703, a providing game stage ID 705, game space control data 707, a player character parameter value list 710, an owned item list 712, event control data 714, an NPC parameter value list 716, and play result data 718. It is clear that other data (for example, access information for enabling data communication with the destination user terminal 1500), can be appropriately included.

The player character parameter value list 710 stores various kinds of data describing the latest state of the player character. For example, the player character parameter value list 710 stores a current position in the game space, motion control information, types of equipment items, and an ability parameter value (for example, a durability value corresponding to HP, offensive power, defensive power, a critical hit occurrence rate, and the like). It is clear that other kinds of data may also be stored as appropriate.

The owned item list 712 stores the types of items owned by the player (or the player character) in association with the number of items.

The event control data 714 stores an event occurrence condition, a parameter value describing an event progress status, data for setting a prize to be given on completion of the event, and the like. It is clear that other kinds of data may also be stored as appropriate.

The parameter values included in the player character parameter value list 710, the owned item list 712, and the event control data 714 can be appropriately changed when a special benefit is given according to the ownership status of the right of use of a copyrighted digital work. In the case where the special benefit includes a release of (grant of a right to use) a new game stage, it is possible to prepare a list of playable game stages (a parameter value indicating available stages) in the content progress control data 700, and add the ID of the new game stage to the list.

Further, when the content is a comic content, the content progress control data 700 may include the parameter value that relates to the control for providing the content, for the user 2 having the right of use. For example, such a parameter may be appropriately set with respect to the change in the upper limit of the image resolution upon the provision, activation/inactivation of reading of character's line by a voice actor or output of sound effects, activation/inactivation of switching between color display and monochrome display, activation/inactivation an automatic page feed function, or the like.

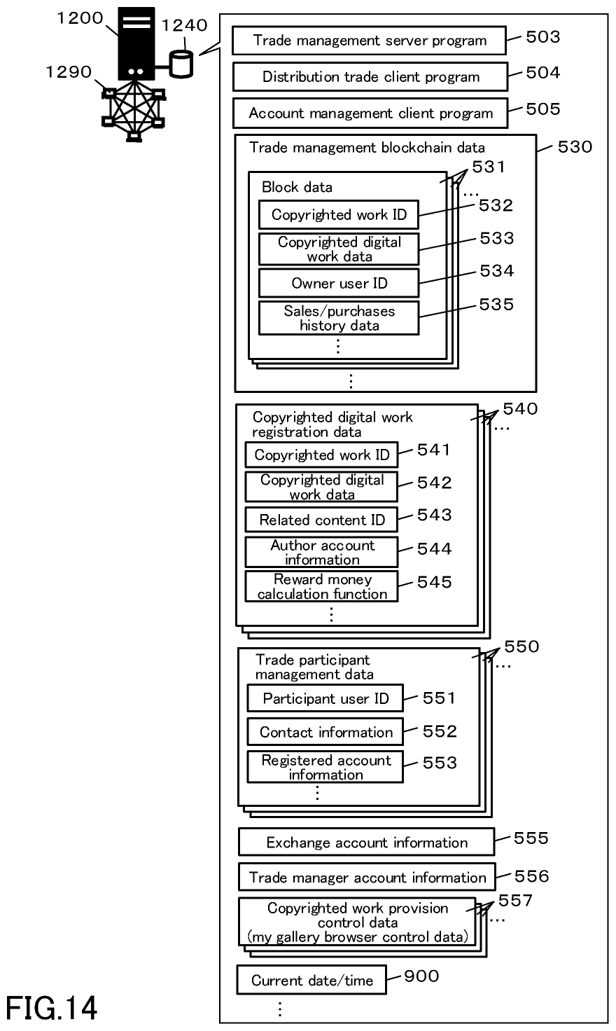

FIG. 14 is a diagram illustrating an example of programs and data stored in the storage section 500 of the trade management server system 1200. The trade management server system 1200 stores a trade management server program 503, a distribution trade client program 504, an account management client program 505, trade management blockchain data 530, copyrighted digital work registration data 540, trade participant management data 550, exchange account information 555, trade manager account information 556, copyrighted work provision control data 557, and current date/time 900. It is clear that other kinds of data may also be stored as appropriate.

The trade management server program 503 is a program calculated and processed in the CPU by the trade management server system 1200 to enable the functions of the right-of-use management section 220, the transfer trade processing section 222, and the copyrighted work providing section 224.

The distribution trade client program 504 is a program for causing the user terminal 1500 to function as a client device so as to enable user's participation in a trade of the right to use a copyrighted digital work by means of the user terminal 1500 and then to enable user's utilization of the copyrighted digital work for which the user obtained the right of use.

The account management client program 505 is a program for enabling the trade management server system 1200 to perform remittance of a crypto asset that relates to a transfer trade of the right of use.

The trade management blockchain data 530 is data of the trade management blockchain 20 (see FIGS. 4 and 6), and includes multiple pieces of block data 531 generated in time series. Each piece of block data 531 includes a unique copyrighted work ID 532, copyrighted digital work data 533, an owner user ID 534 indicating the user 2 as the owner of the right of use, and sales/purchases history data 535 that stores the seller user ID, the date and time when the sale or purchase was made, and the selling/purchase price. It is clear that other kinds of data may also be included as appropriate.

The owner user ID 534 stores the user ID 601 (see FIG. 12) that was registered to enable reception of the content.

The copyrighted digital work data 533 may be omitted from the trade management blockchain data 530.

The copyrighted digital work registration data 540 is prepared for each of a finite number of copies of a copyrighted digital work so as to register the copyrighted digital work as an NFT. Each piece of copyrighted digital work registration data 540 includes a unique copyrighted work ID 541, copyrighted digital work data 542, a related content ID 543, author account information 544, and a reward money calculation function 545. It is clear that other kinds of data may also be included as appropriate.

The related content ID 543 stores a content ID related to the copyrighted digital work. Conversely, when the copyrighted digital work is a copyrighted work that relates to a character used in the content, the related content ID 543 stores information indicating the content.

The author account information 544 is data indicating the author account 18 (see FIG. 5), which is the destination of the remittance of a crypto asset as a reward money required when the sale/purchase was made in the trade of a right of use.

The reward money calculation function 545 stores a function (or table data or a constant) for calculating a reward money based on the selling/purchase price or the like.

The trade participant management data 550 is created for each user who has signed up for the trade of a right of use of a copyrighted digital work. Each piece of trade participant management data 550 includes a participant user ID 551 indicating the user 2 as a registered participant, contact information 552, and registered account information 553. It is clear that other kinds of data may also be included as appropriate.

The participant user ID 551 stores the user ID 601 (see FIG. 12) that was registered to enable reception of the content.

The registered account information 553 is information for enabling use of an account (the purchaser account 13 of a purchaser, the seller account 17 of a seller; see FIG. 5) of a crypto asset used for the trade by a seller or a purchaser.

The exchange account information 555 is information for enabling use of the exchange account 12 (see FIG. 3) that is used for the remittance to give a crypto asset corresponding to the price of the object 4 owned by the user 2, in other words, for the remittance to control exchange between an object and a crypto asset.

The trade manager account information 556 is information for enabling the trade management server system 1200 to use an account (trade manager account 16; see FIG. 5) created for the management of a crypto asset that relates to the trade of a right of use.

The copyrighted work provision control data 557 stores various kinds of data for providing and controlling an environment in which the copyrighted digital work as the target of the right of use is utilized by the user 2 having the right of use.

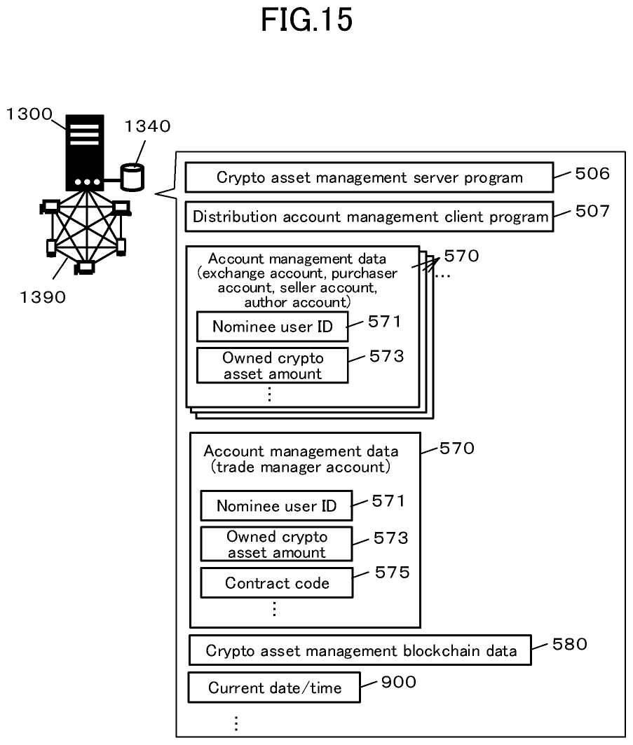

FIG. 15 is a diagram illustrating an example of programs and data stored in the storage section 500 of the crypto asset management server system 1300. The crypto asset management server system 1300 stores a crypto asset management server program 506, a distribution account management client program 507, account management data 570, crypto asset management blockchain data 580, and current date/time 900. It is clear that other kinds of data may also be stored as appropriate.

The crypto asset management server program 506 performs a calculation process in the CPU of the crypto asset management server system 1300 to thereby enable the function of the crypto asset management section 240 (see FIG. 9).

The distribution account management client program 507 is an original program for allowing other computer systems (the trade management server system 1200 and the user terminal 1500) to access the crypto asset management server system 1300, thereby enabling the functions of account management and remittance management. The distribution account management client program 507 is prepared for each of the trade management server system 1200 and the user terminal 1500.

The account management data 570 is created for each crypto asset account, and stores various types of information regarding the account. Each piece of account management data 570 includes a nominee user ID 571 and an owned crypto asset amount 573. A contract code 575 may be included in some account. It is clear that other kinds of data may also be included as appropriate.

The nominee user ID 571 indicates the owner of the crypto asset in the account. For example, the account of the user 2 stores the user ID 601 (see FIG. 12), and the account of the trade management server system 1200 stores a predetermined user ID indicating the manager of the system.

The contract code 575 is a code describing a process automatically executed upon remittance to the account, and is executable by the crypto asset management server system 1300. The contract code 575 is described using an application programming interface (API) provided by the operator of the crypto asset management server system 1300. In the example of the present embodiment, the contract code 575 is set in the trade manager account 16 (see FIG. 5).

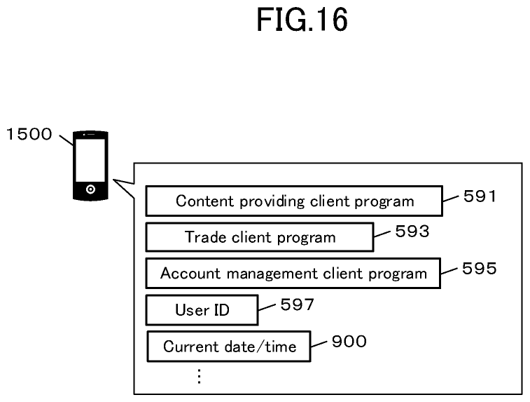

FIG. 16 is a diagram illustrating an example of programs and data stored in the user terminal 1500.

The user terminal 1500 stores a content providing client program 591, a trade client program 593, an account management client program 595, a user ID 597, and current date/time 900, in an IC memory of a control board. It is clear that other kinds of program and data may also be stored as appropriate.

The content providing client program 591 is an application program obtained by downloading the distribution content providing client program 502 (see FIG. 10).

The trade client program 593 is an application program obtained by downloading the distribution trade client program 504 (see FIG. 14).

The account management client program 595 is an application program obtained by downloading the distribution account management client program 507 (see FIG. 15).

More than one of these client programs may be implemented by a common program or a comprehensive program.

The user ID 597 is common user identification information that is referenced by all of the content providing client program 591, the trade client program 593, and the account management client program 595. Execution of any of the client programs causes a setting registration procedure of the user ID 597, and the user 2 inputs and sets the information in this procedure.

The next description concerns the flow of a method for controlling a copyrighted digital work trade in the copyrighted digital work trade support system 1000. It is assumed that the three client programs described above have been installed in the user terminal 1500 and the setting of the user ID 597 has been completed.

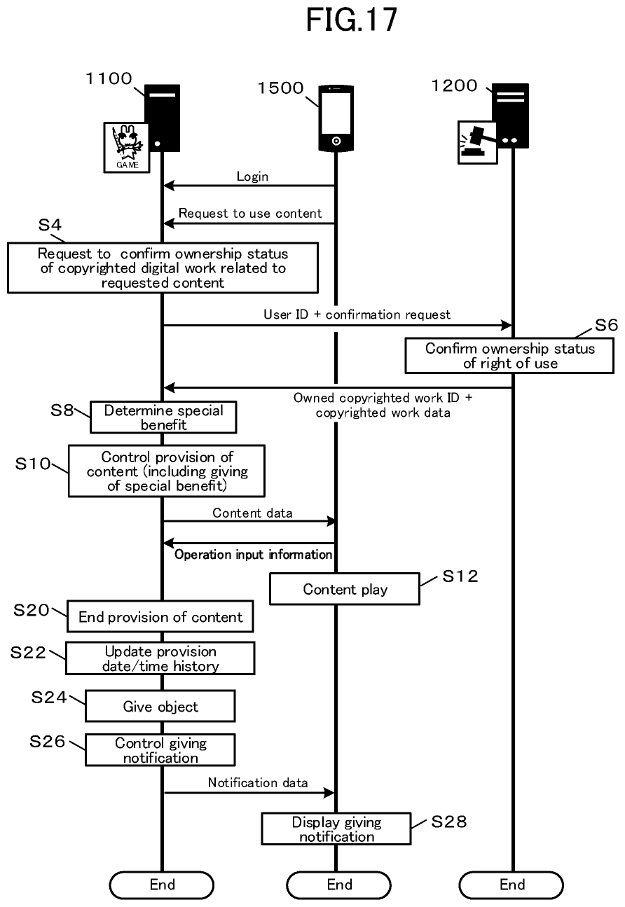

FIG. 17 is a diagram for describing a process flow in the copyrighted digital work trade support system 1000. The diagram describes a flow from content play in the user terminal 1500 to the provision of the object 4.

To start with, the user terminal 1500 accesses and logs into the content providing server system 1100, and transmits a request to use a content. Then, the content providing server system 1100 sends a request to confirm the ownership of the right of use of a copyrighted digital work of the logged-in user 2, to the trade management server system 1200 (step S4). Specifically, the content providing server system 1100 transmits a predetermined confirmation request and the user ID to the trade management server system 1200.

In response to the request, the trade management server system 1200 refers to the trade management blockchain 20, and returns the copyrighted work ID 532 as well as the date and time of purchase when the right of use was acquired, to the content providing server system 1100 (step S6). Specifically, the copyrighted work ID 532 is of the copyrighted digital work for which the received user ID is specified as the owner user ID 534 (see FIG. 14), and the date and time of purchase is included in the sales/purchases history data 535.

The content providing server system 1100 determines a special benefit based on the information thus returned (step S8). Specifically, the content providing server system 1100 sets the right-of-use ownership status data 615 based on the returned information (see FIG. 12), refers to the special benefit giving definition data 516 of the requested content (see FIG. 11), and gives a special benefit according to the definition data for which the special benefit giving requirement is satisfied. If the special benefit is a type that can be given before the start of the content play (for example, release of a new game stage, change in the ability parameter value of the player character, or the like), the special benefit may be given before the start of the content play. If the special benefit is a setting to be given during the content play (for example, occurrence of a special event or the like), the special benefit is set to be activated during the content play. For example, the event to be given as a special benefit is set in the event control data 714.

The content providing server system 1100 starts control of provision of the requested content (step S10). If the given special benefit is a setting to be given during the content play, the content providing server system 1100 also appropriately controls the provision of the setting. As a result, content data for playing the requested content is provided from the content providing server system 1100 to the user terminal 1500, and information of an operation input (operation input information) by the user 2 is provided from the user terminal 1500 to the content providing server system 1100, so that the user 2 can enjoy the content play in the user terminal 1500 (step S12).

When the content is finished (step S20), the content providing server system 1100 updates the provision date/time history 612 (see FIG. 12) of the user 2 (step S22).

Then, the content providing server system 1100 refers to the object giving definition data 514 of the provided content (see FIG. 11), and provides the object 4 to the user 2 according to the definition data for which the giving requirement is satisfied (step S24). Accordingly, the content providing server system 1100 updates the object management data 515 and the object ownership count 614 of the user 2 (see FIG. 12).

Next, the content providing server system 1100 transmits data for displaying the object giving notification 6 (see FIG. 2) to the user terminal 1500 (step S26), and the object giving notification 6 is displayed in the user terminal 1500 (step S28).

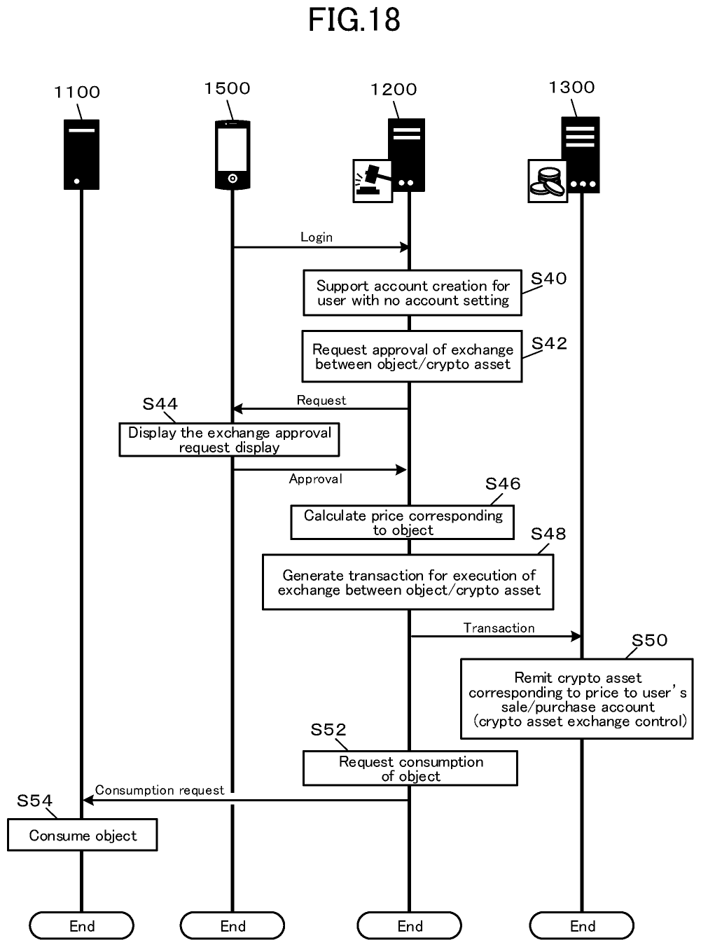

FIG. 18 is a flowchart for describing a process flow for exchanging an object for a crypto asset.

When the user terminal 1500 accesses and logs into the trade management server system 1200, the trade management server system 1200 supports creation of an account for a logged-in user 2 if the user has not set a crypto asset account yet (step S40), for example, by displaying the account opening guide notification 10 (see FIG. 3) in the user terminal 1500.

Specifically, when the user 2 logs in for the first time, the trade management server system 1200 displays the account opening guide notification 10 (see FIG. 3) and guides the user 2 to an account creation procedure in the crypto asset management server system 1300. Alternatively, the trade management server system 1200 performs an account creation procedure using an API provided by the crypto asset management server system 1300.

Next, the trade management server system 1200 displays the exchange approval request display 11 (see FIG. 3) in the user terminal 1500, and requests user's approval to exchange the object 4 owned by the user 2 for a crypto asset (step S42).

The user terminal 1500 displays the exchange approval request display 11 (step S44), and returns an approval result (for convenience, the request is assumed to be approved in this example). After the approval, the trade management server system 1200 refers to the content provision history data 610 (see FIG. 12) of the user 2, and calculates the price corresponding to the object ownership count 614 (see FIG. 12) in the referenced history data according to the exchange rate setting data 517 (see FIG. 11) of the content indicated by the providing content ID 611 in the referred history data (step S46).

Then, the trade management server system 1200 generates a transaction for causing the crypto asset management server system 1300 to execute the exchange between the object 4 and a crypto asset (crypto asset exchange control) (step S48). Specifically, the trade management server system 1200 generates and transmits a transaction for sending a crypto asset corresponding to the price from the exchange account 12 to the purchaser account 13 of the user 2.

In response to this transaction, the crypto asset management server system 1300 performs the exchange of the object 4 for a crypto asset (step S50).

Further, the trade management server system 1200 sends a request for consumption of the object 4 to be exchanged, to the content providing server system 1100 (step S52). Specifically, the trade management server system 1200 transmits the user ID and the content ID for which the object 4 to be exchanged was given, together with a predetermined consumption request, to the content providing server system 1100.

In response to this request, the content providing server system 1100 consumes the object 4 of the user 2 (step S54).

Note that, steps S52 and S54 are omitted in a structure in which the control of the exchange to a crypto asset does not involve consumption of the object 4 (for example, a structure which does not consume the object 4 by performing object-by-object management of data indicating whether the object 4 has been exchanged or not).

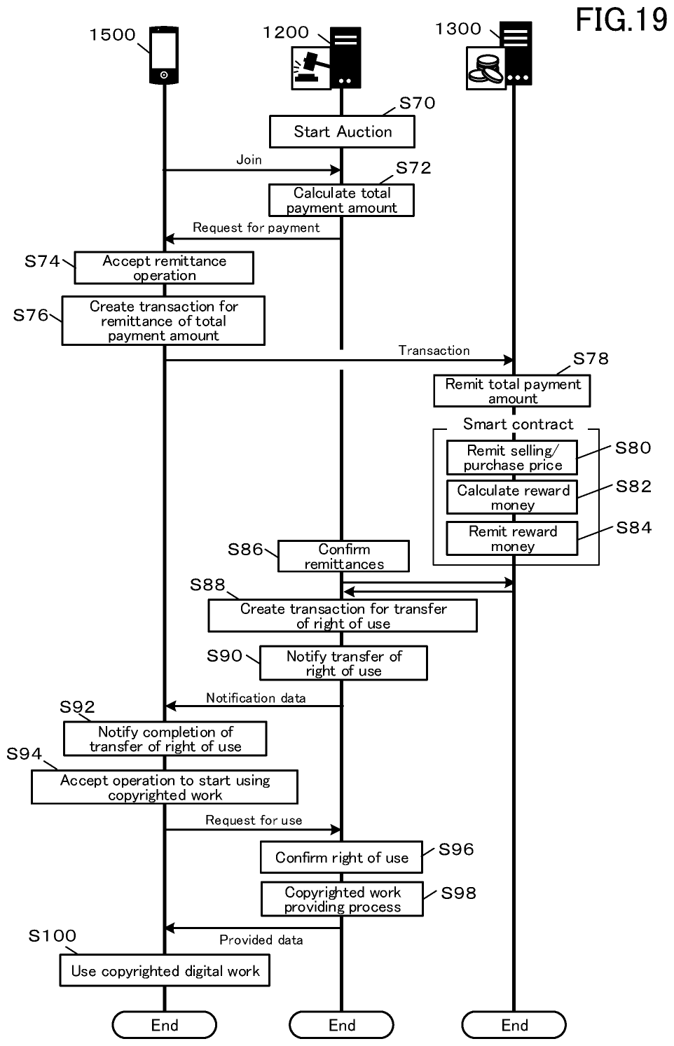

FIG. 19 is a flowchart for describing a process flow relating to a trade of a right to use a copyrighted digital work and use of the copyrighted digital work for which the user has the right of use. It is assumed that the right of use of a copyrighted digital work is registered in advance by the administrator of the trade management server system 1200.

First, the trade management server system 1200 registers a copyrighted digital work to be traded (step S70). The user 2 participates in the auction using the user terminal 1500.

When the purchaser and the selling/purchase price are determined in the auction, the trade management server system 1200 determines that the trade is closed, ends the auction, and calculates the total payment amount (step S72). The total payment amount is the sum of the selling/purchase price (highest bid price at the auction), the brokerage fee based on the price and determined according to a given calculation formula, and the reward money calculated according to the reward money calculation function 545. Then, the trade management server system 1200 sends a request for payment of the total payment amount to the purchaser (winning bidder) (step S72).

In response to this request, the user terminal 1500 displays a remittance operation screen that enables remittance of a crypto asset corresponding to the total payment amount from the purchaser account 13 of the purchasing user 2 to the trade manager account 16, and accepts the remittance operation (step S74). When the approval operation is performed, the user terminal 1500 creates and transmits a transaction of the remittance (step S76). The remittance transaction may be generated and transmitted by the trade management server system 1200 in response to a request from the user terminal 1500 (on reception of a request from the user terminal 1500 in response to the remittance operation input).

Based on the transaction, the crypto asset management server system 1300 remits a crypto asset corresponding to the total payment amount, from the purchaser account 13 to the trade manager account 16 (step S78). Further, the crypto asset management server system 1300 executes the contract code 575 set in the trade manager account 16, and remits the selling/purchase price from the trade manager account 16 to the seller account 17 of the seller user (step S80). Further, the crypto asset management server system 1300 calculates the reward money (step S82), and remits the reward money from the trade manager account 16 to the author account 18 (step S84). That is, the smart contract is executed.

The trade management server system 1200 confirms execution of all these remittance processes (step S86), and creates and sends a transaction for changing the right of use of the copyrighted digital work, as the trade target, from the seller to the purchaser (step S88). Next, the trade management server system 1200 executes a process of causing the user terminal 1500 to display a notification that the transfer of the right of use is completed (step S90), and then the user terminal 1500 displays the notification that the transfer of the right of use is completed (step S92).

When the user terminal 1500 receives an operation to start using a copyrighted digital work (step S94), the user terminal 1500 transmits a use request to the trade management server system 1200 together with the user ID.

In response to the request, the trade management server system 1200 confirms the digital copyright owned by the user of the user terminal 1500 based on the received user ID (step S96), starts a process of providing the corresponding copyrighted digital work, and transmits the provided data to the user terminal 1500 (step S98).

Subsequently, the user terminal 1500 enables use of the copyrighted digital work (for example, browsing of the copyrighted digital work in my gallery) (step S100).

The present embodiment thus described above can provide an advantageous mechanism for all parties involved in creation and use of copyrighted digital works, including users who use contents employing copyrighted digital works, authors of the copyrighted digital works, and content providers.

More specifically, the user 2 can obtain the object 4 by using the content, can convert the object 4 into a crypto asset, and can thereby trade a right to use a copyrighted digital work. From the standpoint of the user 2, the user 2 can obtain the crypto asset required for the trade by a simple act of using a content, and hence does not need to purchase a crypto asset using the currency in the real world. Eventually, the user 2 can more easily join the trade of the right of use of a copyrighted digital work.

From the standpoint of the author of a copyrighted digital work, the trade of the right to use his/her works is autonomously performed insofar as he/she creates a crypto asset account. The author can thus obtain a reward money corresponding to the selling/purchase price. Such a mechanism helps to improve author's motivation in creative activities.

From the standpoint of the content provider, this mechanism, in which the right of use of a copyrighted digital work is tradable by a simple act of playing a content provided by him/herself, leads to a new promotion means which did not exist in the past.

Further, the user 2 having the right of use of the copyrighted digital work obtains a special benefit that gives an advantage during the content play. Therefore, the user 2 is more strongly invited to trade the rights to use copyrighted digital works. The resulting rise in the trade of the right of use increases the income of the authors, encourages the users to play the content more actively, and thereby benefits the content providers.

Furthermore, the rate of exchange from the object to a crypto asset is adjustable. Hence, by adjusting the exchange rate, it is possible to adjust the intensity of inviting the user to trade the right of use of a copyrighted digital work, and thereby appropriately adjusting the intensity of the cycle of “giving an object to a user→inviting the user to trade the right of use of a copyrighted digital work, and thereby activating the trade→encouraging the user to use the content more actively through the ownership of the right of use”. Further, since this embodiment provides the exchange rate for each content and allows involvement of the content provider in the process of setting the exchange rate, the exchange rate can be adjusted in accordance with the operation situation of the content provider. This further improves the usability as the promotion means.

### MODIFICATION EXAMPLE

The embodiments to which the present disclosure is applied have been described so far. However, the modes to which the present disclosure is applicable are not limited to the foregoing embodiments, and the components can be added, omitted, or changed as appropriate.

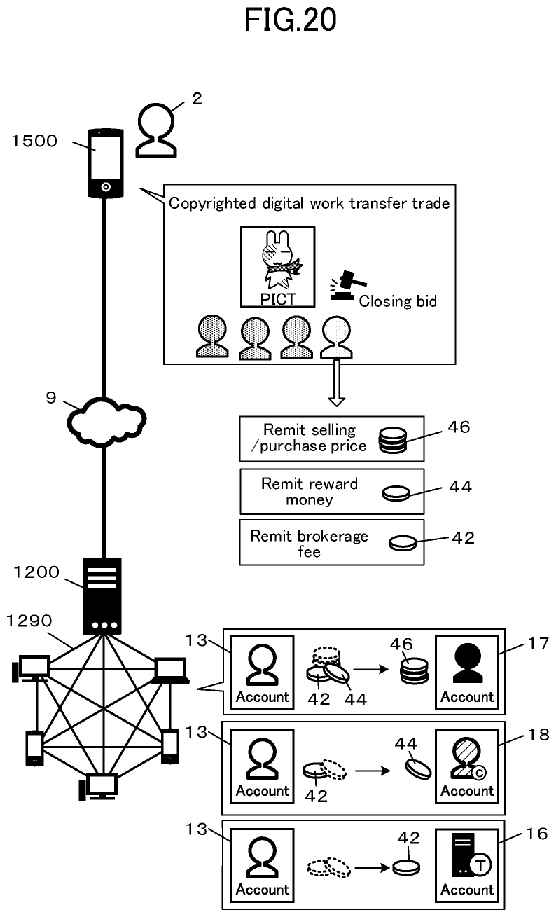

For example, in the above-described embodiment, the remittance of the selling/purchase price, the remittance of the reward money, and the remittance of the brokerage fee are implemented by the smart contact, but implementation of the remittances should not be limited thereto. As shown in FIG. 20, the remittance of the selling/purchase price, the remittance of the reward money, and the remittance of the brokerage fee may be executed independently by the purchaser operating the user terminal 1500. In this case, the type of the crypto asset used for the remittance may be selected separately for each remittance.

Further, for example, in the above-described embodiment, the object 4 is consumed and exchanged for a crypto asset; however, it is also possible to give a crypto asset corresponding to the price without consuming the object 4. For example, when the object 4 is an item that can be used in the game, a unexchanged/exchanged flag may be set and managed separately for each object 4, thereby keeping the object 4 usable in the game even after the exchange was done. Alternatively, crypto assets corresponding to the price of 10 objects 4 may be given every time the number of objects 4 owned by the user exceeds n×10 (n is an integer).

In the above-described embodiment, it is the author of the copyrighted digital work who is given a reward money corresponding to the sale/purchase of the right of use of the copyrighted digital work. Alternatively, the reward money may be given to the copyright holder of the copyrighted digital work instead of the author of the copyrighted digital work. It is clear that the author of the copyrighted digital work and the copyright holder of the copyrighted digital work may be the same person.

Although only some embodiments of the present invention have been described in detail above, those skilled in the art will readily appreciate that many modifications are possible in the embodiments without materially departing from the novel teachings and advantages of this invention. Accordingly, all such modifications are intended to be included within scope of this invention.

What is claimed is:

1. A computer system comprising:
at least one processor or circuit programmed to:
provide a content to users;
give an object in accordance with a use status of the content and manage the object for each of the users;
connect to a first blockchain network that relates to a first blockchain in which information regarding a trade of a crypto asset is written, and manage, for each of the users, the crypto asset owned by the user;
connect to a second blockchain network that relates to a second blockchain in which information regarding a trade of a right of use of a copyrighted digital work is written, and manage, for each of the users, the right of use owned by the user;
provide a transfer trade function that mediates sale and purchase of the right of use between the users using the crypto asset; and
give the crypto asset corresponding to a given price to the user from a predetermined account related to the first blockchain network, in exchange for the object owned by the user.

2. The computer system as defined in claim 1, wherein
the at least one processor or circuit is further programmed to:
connect to the first blockchain network and manage the crypto asset owned by an author of the copyrighted digital work, an author who is also a copyright holder of the copyrighted digital work, or the like; and
collect the crypto asset corresponding to a predetermined reward money for sale and purchase of the right of use upon intermediation of the sale and purchase, and give the crypto asset to the author or the like.

3. The computer system as defined in claim 1, wherein
a character or the like appears in the content, the character or the like comprising a plurality of characters and/or items for which parameters are set, and
the copyrighted digital work is a copyrighted work that relates to an image of the character or the like.

4. The computer system as defined in claim 2, wherein
a character or the like appears in the content, the character or the like comprising a plurality of characters and/or items for which parameters are set, and
the copyrighted digital work is a copyrighted work that relates to an image of the character or the like.

5. The computer system as defined in claim 1, wherein
providing the content includes giving a special benefit related to the content to the user having the right of use.

6. The computer system as defined in claim 3, wherein
providing the content includes giving a special benefit related to the content to the user having the right of use, by changing a value of the parameter of the character or the like corresponding to the right of use.

7. The computer system as defined in claim 4, wherein
providing the content includes giving a special benefit related to the content to the user having the right of use, by changing a value of the parameter of the character or the like corresponding to the right of use.

8. The computer system as defined in claim 3, wherein
providing the content includes giving a special benefit related to the content to the user having the right of use, after changing the special benefit according to how many rights of use related to the same character or the like are owned by the user.

9. The computer system as defined in claim 4, wherein
providing the content includes giving a special benefit related to the content to the user having the right of use, after changing the special benefit according to how many rights of use related to the same character or the like are owned by the user.

10. The computer system as defined in claim 1, wherein
the content is a game.

11. The computer system as defined in claim 1, wherein
the content is a comic.

12. The computer system as defined in claim 1, wherein
giving the crypto asset to the user in exchange for the object includes determining the price with respect to the object based on a given exchange rate; and
providing the content includes setting the exchange rate.

13. A method for controlling a trade of a copyrighted digital work executed by a computer system, the method comprising:
providing a content to users;
giving an object in accordance with a use status of the content and managing the object for each of the users;
connecting to a first blockchain network that relates to a first blockchain in which information regarding a trade of a crypto asset is written, and managing, for each of the users, the crypto asset owned by the user;
connecting to a second blockchain network that relates to a second blockchain in which information regarding a trade of a right of use of a copyrighted digital work is written, and managing, for each of the users, the right of use owned by the user;
providing a transfer trade function that mediates sale and purchase of the right of use between the users using the crypto asset; and
giving the crypto asset corresponding to a given price to the user from a predetermined account related to the first blockchain network, in exchange for the object owned by the user.
